(19) United States
(12) Patent Application Publication
(10) Pub. No.: US 2018/0137253 A1
(43) Pub. Date: May 17, 2018

(54) METHOD AND APPARATUS FOR DETERMINING EVALUATION FACTOR FOR PHYSIOLOGICAL CONDITION

(71) Applicant: BOE TECHNOLOGY GROUP CO., LTD., Beijing (CN)

(72) Inventor: Hui LI, Beijing (CN)

(21) Appl. No.: 15/812,054

(22) Filed: Nov. 14, 2017

(30) Foreign Application Priority Data
Nov. 14, 2016 (CN) 201611024908.1

(51) Int. Cl. G06F 19/00; G06N 5/02

(52) U.S. Cl. CPC G06F 19/3431; G06N 5/022; G06F 19/3437

(57) ABSTRACT

The present discloses provides a method and apparatus for determining an evaluation factor for a physiological condition. The method includes steps of: obtaining a plurality of first risk factors based on knowledge for a physiological condition; obtaining a plurality of potential second risk factors based on clinical data for the physiological condition; performing logistic regression model analysis on the potential second risk factors to obtain second risk factors; calculating a correlation coefficient between the first risk factor and the second risk factor to determine correlation between the first risk factor and the second risk factor; and determining, based on the correlation between the first risk factors and the second risk factors, the first risk factor and the second risk factor that are valuable for the physiological condition to be evaluation factors for the physiological condition.

### CROSS-REFERENCE TO RELATED APPLICATION

This application claims priority to Chinese Patent Application No. 2016110249081, filed on Nov. 14, 2016, the contents of which are incorporated by reference in the entirety.

### TECHNICAL FIELD

The present disclosure relates to the field of medical big data processing, and more particularly to a method and apparatus for determining an evaluation factor for a physiological condition.

### BACKGROUND

In the field of medical research, a risk prediction model is generally used to predict initiation potential of a disease. For groups, their disease risk probabilities are classified by a risk prediction model, and different targeted early warnings are given to groups with different risk probabilities, which can be regarded as the first step of precision medical treatment and also help different groups to correct and adjust their health habits and lifestyle more timely. In addition, for individuals, a risk prediction model helps a patient to better know his/her own risk of disease, and increase his/her knowledge about disease risk factors, so that lifestyle intervention or drug intervention can begin in advance to decrease morbidity and mortality of the disease.

### SUMMARY

In an aspect, the present disclosure provides a method for determining an evaluation factor for a physiological condition, including steps of:

obtaining a plurality of first risk factors based on knowledge for a physiological condition;

obtaining a plurality of potential second risk factors based on clinical data for the physiological condition;

performing logistic regression model analysis on the potential second risk factors to obtain second risk factors;

calculating, for each of the first risk factors, respective correlation coefficients between the first risk factor and the plurality of second risk factors, to determine correlation between the first risk factors and the second risk factors; and

determining, based on the correlation between the first risk factors and the 10 second risk factors, at least one first risk factor and at least one second risk factor that are valuable for the physiological condition to be evaluation factors for the physiological condition.

Optionally, a calculation formula for performing logistic regression model analysis on the potential second risk factors is:

$$F ( x ) = \frac{{e}^{t}}{( 1 + {e}^{t} )} = \frac{1}{( 1 + {e}^{- t} )} , \\ t = {β}_{0} + {β}_{1} {x}_{1} + {β}_{2} {x}_{2} + L + {β}_{n} {x}_{n} ,$$

where x₁, x₂, . . . , xₙ are the potential second risk factors, n is the number of the potential second risk factors, and β₁, β₂, β₃, . . . βₙ, are regression coefficients corresponding to the potential second risk factors.

Optionally, the correlation coefficient r between the first risk factor and the 20 second risk factor is calculated using a calculation formula:

$$r = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2}} \sqrt{{\sum }_{i = 1}^{n} {( {y}_{i} - \overline{y} )}^{2}}}$$

where X=(x₁, x₂, . . . , xₙ) and Y=(y₁, y₂, . . . , yₙ) are first risk factor data and second risk factor data, respectively, x and Y are average values of X and Y, respectively, and n is the number of samples for the first risk factor and the number of samples for the second risk factor.

Optionally, the first risk factor and the second risk factor between which the correlation coefficient is smaller than 0.7 are determined to be the evaluation factors for the physiological condition.

Optionally, the plurality of first risk factors based on knowledge include evaluation factors extracted from medical journals or literature that have been used for evaluating the physiological condition; and

the plurality of second risk factors based on clinical data include at least one of personal general information, clinical diagnostic information, drug information, laboratory information and physiological index information.

In another aspect, the present disclosure provides an apparatus for determining an evaluation factor for a physiological condition, including a storage device and one or more processors coupled to the storage device, wherein the storage device is configured to store computer-executable instructions for causing the one or more processor to:

obtain a plurality of first risk factors based on knowledge for a physiological condition;

obtain a plurality of potential second risk factors based on clinical data for the physiological condition;

perform logistic regression model analysis on the potential second risk factors to obtain second risk factors;

calculate, for each of the first risk factors; respective correlation coefficients between the first risk factor and the plurality of second risk factors to determine correlation between the first risk factors and the second risk factors; and

determine, based on the correlation between the first risk factors and the second risk factors, at least one first risk factor and at least one second risk factor that are valuable for the physiological condition to be the evaluation factors for the physiological condition.

Optionally, a calculation formula for performing the logistic regression model analysis on the potential second risk factors is:

$$F ( x ) = \frac{{e}^{t}}{( 1 + {e}^{t} )} = \frac{1}{( 1 + {e}^{- t} )} , \\ t = {β}_{0} + {β}_{1} {x}_{1} + {β}_{2} {x}_{2} + L + {β}_{n} {x}_{n} ,$$

where x₁, x₂, . . . , xₙ are the potential second risk factors, n is the number of the potential second risk factors, and β₁, β₂, β₃, . . . , βₙ are regression coefficients corresponding to the potential second risk factors.

Optionally, the correlation coefficient r between the first risk factor and the second risk factor is calculated using a calculation formula:

$$r = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2}} \sqrt{{\sum }_{i = 1}^{n} {( {y}_{i} - \overline{y} )}^{2}}}$$

where X=(x₁, x₂, . . . , xₙ) and Y=(y₁, y₂, . . . , yₙ) first risk factor data and 10 second risk factor data, respectively, x and y are average values of X and Y, respectively, and n is the number of samples for the first risk factor and the number of samples for the second risk factor.

Optionally, the first risk factor and the second risk factor between which the correlation coefficient is smaller than 0.7 are determined to be the evaluation factors for the physiological condition.

Optionally, the plurality of first risk factors based on knowledge include evaluation factors extracted from medical journals or literature that have been used for evaluating the physiological condition; and

the plurality of second risk factors based on clinical data include at least one of personal general information, clinical diagnostic information, drug information, laboratory information and physiological index information.

### BRIEF DESCRIPTION OF THE DRAWINGS

FIG. 1 is a flowchart of a method for determining an evaluation factor for a physiological condition in an embodiment of the present disclosure; and

FIG. 2 is a schematic block diagram of an apparatus for determining an evaluation factor for a physiological condition in an embodiment of the present disclosure.

### DETAILED DESCRIPTION

To enable those skilled in the art to better understand technical solutions of the present disclosure, a method and an apparatus for determining an evaluation factor for a physiological condition provided in the present disclosure will be described in detail below in conjunction with the accompanying drawings and specific implementations.

Risk factors need to be determined for establishing a risk prediction model. Currently, there are two existing ways to obtain the risk factors. One is to obtain knowledge-based risk factors, that is, to extract risk factors from medical guidelines or medical literature, these risk factors are usually qualitative, and can hardly be quantified for disease risk prediction. The other is to obtain data-based risk factors, that is, to obtain risk factors by observing clinical data, however, the risk factors obtained directly from the clinical data are usually scattered, and it is difficult to extract valuable risk factors from tons of data.

It can be seen that, risk factors required by a risk prediction model are determined in a relatively simple way. However, there is no effective way to combine the above two ways to get more comprehensive and valuable risk factors.

Embodiments of the present disclosure provides a method for determining an evaluation factor for a physiological condition. In the method, knowledge-based risk factors and data-based risk factors are combined to obtain more comprehensive risk factors, so that the physiological condition of a human body can be determined more accurately, which provides an effective basis for early lifestyle intervention or drug intervention, so as to lower morbidity and mortality of a disease and ensure the quality of life of an individual.

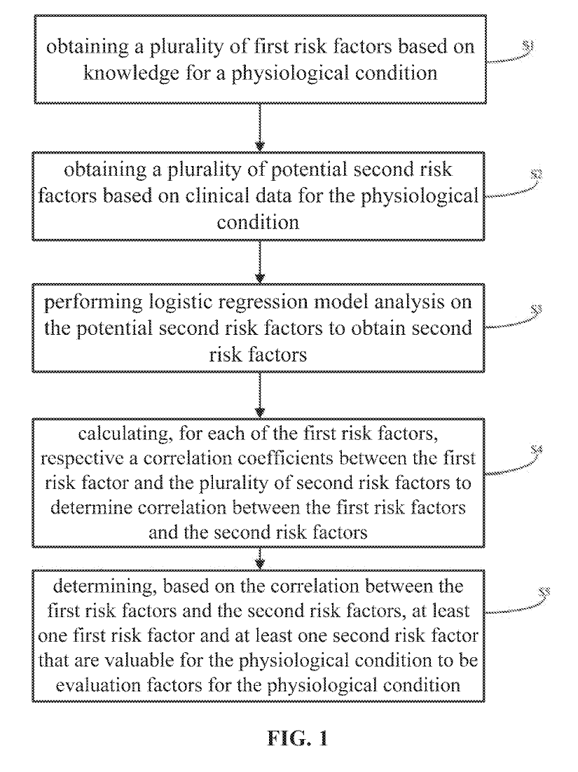

As shown in FIG. 1, the step includes steps S1 to S5.

At step S1, a plurality of first risk factors based on knowledge are obtained for a physiological condition.

The plurality of first risk factors based on knowledge include evaluation factors extracted from medical journals or literature that have been used for evaluating the physiological condition. The risk factors based on knowledge extracted from the knowledge base (medical journals or literature) are regular risk factors distilled and summarized from multi-party experiments or numerous cases by domestic and foreign experts, have relatively high scientificity and authority in evaluating a physiological condition of a human body, and can generally be used as a diagnostic criterion for the condition.

At step S2, a plurality of potential second risk factors based on clinical data are obtained for the physiological condition.

The plurality of second risk factors based on clinical data include at least one of personal general information, clinical diagnostic information, drug information, laboratory information and physiological index information.

Clinical data involve many types of big data, and mainly include personal general information, clinical diagnosis information, drug information, laboratory information, physiological index information, and the like. For example, the general information may include age, gender, height, weight, drinking or not, smoking, and the like; the clinical diagnosis information may include diabetes, chronic atrial fibrillation, obstructive pulmonary disease, peripheral vascular disease, hypertension, cerebrovascular disease, acute myocardial infarction, aortic aneurysm, respiratory symptoms, and the like; drug information may include: β-receptor antagonists, diuretics, calcium channel blockers, other antihypertensive drugs, and the like; laboratory information may include: lipid panel, basal metabolic rate, CBC, liver function test, high sensitive c-reactive protein, glomerular filtration rate, microalbuminuria, glucose, glycosylated hemoglobin, and the like; and physiological index information may include: pulse, systolic blood pressure, diastolic blood pressure, pulse pressure, and the like.

Based on steps S1 and S2, the risk factors based on knowledge and the risk factors based on clinical data may be integrated to obtain more comprehensive risk factors. Especially for multifarious and diverse clinical data, valuable risk factors may be selected from the potential risk factors. At the same time, the risk factors based on clinical data and the risk factors based on knowledge are allowed to have low redundancy.

At step S3, logistic regression model analysis is performed on the potential second risk factors.

In this step, the clinical data are processed first to select possibly valuable potential second risk factors based on clinical data. For example, it is feasible to clean data, fill missing data, and the like, then potential risk factors (e.g., the second potential risk factor) and a target physiological condition (e.g., with or without gestational diabetes mellitus) are extracted.

Specifically, logistic regression (LR) modeling is performed based on the potential second risk factors and the target physiological condition selected from the data, and risk factors that are relatively effective are extracted, as the second risk factors, from the potential second risk factors according to the modeling result.

A calculation formula for performing logistic regression model analysis on the potential second risk factors is:

$$F ( x ) = \frac{{e}^{t}}{( 1 + {e}^{t} )} = \frac{1}{( 1 + {e}^{- t} )} , \\ t = {β}_{0} + {β}_{1} {x}_{1} + {β}_{2} {x}_{2} + L + {β}_{n} {x}_{n} ,$$

where x₁, x₂, . . . , xₙ are the potential second risk factors, n is the number of the potential second risk factors, and β₁, β₂, β₃, . . . , βₙ are regression coefficients corresponding to the potential second risk factors.

The potential second risk factors and the target physiological condition selected from the data are analyzed and trained by the logistic regression model, and the second risk factors that are relatively effective are extracted from the second potential risk factors according to the analysis result of the logistic regression model.

It should be understood that the order in which step S1 to step S3 are performed is not limited to the above order, any order is feasible as long as it is ensured that step S3 is performed after step S2.

At step S4, for each of the first risk factors, respective correlation coefficients between the first risk factor and the plurality of second risk factors is calculated, so as to determine correlation between the first risk factors and the second risk factors.

In this step, a redundant risk factor is excluded by calculating the correlation coefficients. Correlation analysis refers to a process of analyzing two or more correlated variable elements to determine the correlation between the two or more variable elements. In an embodiment of the present disclosure, correlation analysis is performed on the second risk factors subjected to the logistic regression model and the first risk factors based on knowledge. If the correlation between the second risk factor and the first risk factor is relatively high, the second risk factor is considered to be a redundant item and is removed; if the correlation between the second risk factor and the first risk factor is relatively low, the second risk factor is a non-redundant item, and is remained.

Here, the correlation coefficient serves as a statistical indicator for reflecting the correlation between the variables, and the correlation coefficient r between a first risk factor and a second risk factor is calculated using the following calculation formula:

$$r = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2}} \sqrt{{\sum }_{i = 1}^{n} {( {y}_{i} - \overline{y} )}^{2}}}$$

where X=(x₁, x₂, . . . , xₙ) and Y=(y₁, y₂, . . . , yₙ) are first risk factor and second risk factor, respectively, x and y are average values of X and Y, respectively, and n is the number of samples for the first risk factors and the number of samples for the second risk factors.

At step S5, at least one first risk factor and at least one second risk factor that are valuable for the physiological condition are determined to be evaluation factors for the physiological condition based on the correlation between the first risk factors and the second risk factors.

In this step, the correlation obtained in step S4 is analyzed comprehensively, and the second risk factors based on clinical data and the first risk factors based on knowledge are integrated to obtain the final risk factors serving as the evaluation factors. For example, for a physiological condition, the first risk factor and the second risk factor between which the correlation coefficient is smaller than 0.7 are determined to be the evaluation factors for the physiological condition.

Embodiments of the present disclosure further provide an apparatus for determining an evaluation factor for a physiological condition.

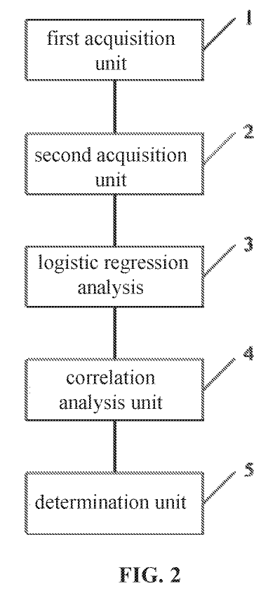

As shown in FIG. 2, the apparatus includes a first acquisition unit 1, a second acquisition unit 2, a logistic regression analysis unit 3, a correlation analysis unit 4 and a determination unit 5. The first acquisition unit 1 is configured to obtain a plurality of first risk factors based on knowledge for a physiological condition. The second acquisition unit 2 is configured to obtain a plurality of potential second risk factors based on clinical data for the physiological condition. The logistic regression analysis unit 3 is configured to perform logistic regression model analysis on the potential second risk factors to obtain second risk factors. The correlation analysis unit 4 is configured to calculate, for each of the first risk factors, respective correlation coefficients between the first risk factors and the plurality of second risk factors to determine correlation between the first risk factors and the second risk factors. The determination unit 5 is configured to determine, based on the correlation between the first risk factors and the second risk factors, at least one first risk factor and at least one second risk factor that are valuable for the physiological condition to be evaluation factors for the physiological condition.

In the logistic regression analysis unit 3, potential second risk factors and a target physiological condition selected from the data are analyzed and trained by a logistic regression model, and the second risk factors that are relatively effective are extracted from the second potential risk factors according to the analysis result of the logistic regression model. A calculation formula for performing the logistic regression model analysis on the potential second risk factors is:

$$F ( x ) = \frac{{e}^{t}}{( 1 + {e}^{t} )} = \frac{1}{( 1 + {e}^{- t} )} , \\ t = {β}_{0} + {β}_{1} {x}_{1} + {β}_{2} {x}_{2} + L + {β}_{n} {x}_{n} ,$$

where x₁, x₂, . . . , xₙ are the potential second risk factors, a is the number of the potential second risk factors, and β₁, β₂, β₃, . . . , βₙ are regression coefficients corresponding to the potential second risk factors.

In the correlation analysis unit 4, a correlation coefficient between the first risk factor and the second risk factor is calculated to determine correlation between the first risk factor and the second risk factor. The correlation coefficient r between the first risk factor and the second risk factor is calculated using the following calculation formula:

$$r = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2}} \sqrt{{\sum }_{i = 1}^{n} {( {y}_{i} - \overline{y} )}^{2}}}$$

where X=(x₁, x₂, . . . , xₙ) and Y=(y₁, y₂, . . . yₙ) are first risk factor and 15 second risk factor, respectively, x and y are average values of X and Y, respectively, and n is the number of samples for the first risk factors and the number of samples for the second risk factors.

In the determination unit 5, effective risk factors are determined through calculation of the correlation coefficients. If the correlation between the second risk factor and the first risk factor is relatively high, the second risk factor is considered to be a redundant item and is removed; if the correlation between the second risk factor and the first risk factor is relatively low, the second risk factor is a non-redundant item, and is remained. For example, for a physiological condition, the first risk factor and the second risk factor between which the correlation coefficient is smaller than 0.7 are determined to be the evaluation factors for the physiological condition.

In the first acquisition unit 1, the plurality of first risk factors based on knowledge include evaluation factors extracted from medical journals or literature that have been used for evaluating the physiological condition; and in the second acquisition unit 2, the plurality of second risk factors based on clinical data include at least one of personal general information, clinical diagnostic information, drug information, laboratory information and physiological index information. More comprehensive risk factors are obtained by combining the risk factors based on knowledge and the risk factors based on clinical data.

For example, the apparatus according to an embodiment of the present disclosure may be implemented a storage device and one or more processors, the storage device stores computer-executable instructions for causing the one or more processors to determine an evaluation factor for a physiological condition such that the processor achieves the functions of the first acquisition unit 1, the second acquisition unit 2, the logistic regression analysis unit 3, the correlation analysis unit 4, and the determination unit 5. Examples of suitable storage devices include, but are not limited to, magnetic disks or tapes; optical storage media such as compact disks (CDs) or DVDs (digital versatile disks); flash memories; and other non-transitory media. Optionally, the storage device is non-transitory memory.

Needless to say, the apparatus according to the embodiments of the present disclosure is not limited thereto, and may also be implemented in other forms through a combination of software and hardware.

In the method and apparatus for determining an evaluation factor for a physiological condition provided in the embodiments of the present disclosure, risk factors based on knowledge and potential risk factors based on clinical data are comprehensively extracted, and both logistic regression model analysis and correlation analysis are used, which can effectively improve quality of the risk factors, decrease modeling dimension of a risk prediction model, reduce difficulty in establishing the risk prediction model and provide effective evaluation factors, thereby providing an effective basis for risk prediction of the physiological condition.

According to the above-described method and apparatus for determining an evaluation factor for a physiological condition, evaluation for gestational diabetes mellitus will be described below in detail as an example.

In step S1, first risk factors based on knowledge are obtained. Specifically, description about gestational diabetes mellitus (GDM) in medical guidelines is that a patient can be diagnosed as GDM if any one of the following conditions is met:

1. a patient who has been diagnosed with diabetes mellitus before pregnancy; and

2. a pregnant woman who did not do blood glucose test before pregnancy, especially a pregnant woman with high-risk factors for GDM, whether the pregnant woman has diabetes mellitus or not needs to be determined on the first prenatal test, and the pregnant women should be diagnosed with GDM if her blood sugar rises up to any one of the following criteria in gestation period: (1) fasting plasma glucose (FPG) is larger than or equal to 7.0 mmol/L (126 mg/dl); (2) in 75 g oral glucose tolerance test (OGTT); 2-hour blood glucose after 75 g oral glucose is larger than or equal to 11.1 mmol/L (200 mg/dl); (3) with typical symptoms of hyperglycemia or hyperglycemic crisis with a random blood glucose larger than or equal to 11.1 mmol/L (200 mg/dl); (4) glycohemoglobin (HbA1c) is larger than or equal to 6.5% (using method standardized by national glycohemoglobin standardization program/diabetes control and complication trial, NGSP/DCCT in short), but it is not recommended to routinely use HbA1c during pregnancy to screen for diabetes mellitus. High-risk factors for GDM include obesity (especially severe obesity), a first degree relative with type 2 diabetes mellitus (T2DM), history of GDM, or history of macrosomia delivery, polycystic ovary syndrome, fasting urine sugar being repeatedly positive in early pregnancy, and the like.

It can be known from the above that the first risk factors based on knowledge for GDM are shown in Table 1.

TABLE 1
list of first risk factors based on knowledge for GDM

| | |
|---|---|
| First risk factors | result |

| | | |
|---|---|---|
| BMI | ≥25 | high-risk |
| a first degree relative | TRUE | factors for |
| with T2DM | | GDM |
| history of GDM | TRUE | |
| history of macrosomia | TRUE | |
| delivery | | |
| polycystic ovary | TRUE | |
| syndrome | | |
| fasting urine sugar in | Repeatedly | |
| early pregnancy | positive | |
| diabetes mellitus | diagnosed | PGDM |
| | before | |
| | pregnancy | |
| High-risk factors for | TRUE | |
| DM | | |
| FPG | ≥7.0 mmol/L | |
| 2-hour blood glucose | 11.1 mmol/L | |
| after meal | | |
| random blood glucose | 11.1 mmol/L | |
| hyperglycemia | TRUE | |
| hyperglycemic crisis | TRUE | |
| HbA1c | ≥6.5% | |

In step S2, potential second risk factors based on clinical data are obtained. For example, potential risk factors include age, weight, height, gestational age and the like, and the target physiological condition is gestational diabetes mellitus.

In Step S3, in a LR model screening process, case data are combined with the target condition, second risk factors are selected through LR model modeling, and a result is shown in Table 2.

Here, an existing library of R programming language such as the Im( ) function may be directly used for project implementation, the value of Pr therein is judged, and the result is shown in Table 2. For obtained coefficients (variables) of the linear regression equation, estimates and standard errors (i.e., the second and third columns of Table 2) can be calculated using a function in the R programming language. According to the established model, in order to test the importance of these coefficients in Table 2 (i.e., to verify whether these coefficients are valuable), hypothesis tests with the coefficients being 0 are performed, that is, H₀:βᵢ=0. Student's t test is usually used to verify these hypotheses. The value of t is defined as the ratio of the estimate of the coefficient to the standard error thereof, the fifth column (Pᵣ(>|t|) is used to denote the probability of denying the hypothesis that the coefficient is zero. If Pr is equal to 0.05 (corresponding to the sixth column “correlation” in Table 2), it indicates it can be confirmed with a confidence level of 95% that the existing hypothesis is erroneous and the hypothesis of the coefficient being zero is rejected.

TABLE 2
list of LR selecting result of clinical data

| | | standard | | | |
|---|---|---|---|---|---|
| coefficient | estimate | error | value of t | Pᵣ (>\|t\|) | correlation |
| intercept | 1.3773 | 0.8878 | 1.55 | 0.12081 | |
| name | 0.2803 | 0.2391 | 1.17 | 0.24108 | |
| age | −0.0443 | 0.0182 | −2.43 | 0.0153 | * |
| give birth | 0.0948 | 0.0322 | 2.94 | 0.00326 | ** |
| or not | | | | | |
| height | 0.3977 | 0.2915 | 1.36 | 0.17251 | ** |
| weight | −0.3247 | 0.0898 | −3.62 | 0.0003 | *** |
| education | 0.0211 | 0.0505 | 0.42 | 0.67685 | |
| occupation | 0.0309 | 0.0718 | 0.43 | 0.66663 | |
| HbA1c | −0.4685 | 0.0909 | −5.15 | 2.6E−07 | *** |

In step S4, correlation analysis is performed based on the data in Table 1 and Table 2. For example, data such as FPG, 2-hour blood glucose after meal, random blood glucose and the like are extracted from Table 1, and data such as weight, age and the like are extracted from Table 2, and correlation analysis is performed on corresponding data to obtain correlation coefficients between the first risk factors from Table 1 and the second risk factors from Table 2.

In step S5, valuable risk factors are determined based on the correlation coefficients between the first risk factors based on knowledge and the second risk factors based on clinical data. If the correlation coefficient between the 20 second risk factor and the first risk factor is larger than 0.7, the second risk factor is a factor that has relatively high correlation with the first risk factor and is thus abandoned or excluded.

In existing evaluating method for a physiological condition, the selected risk factors are either based on knowledge only or based on clinical data only, and thus bias and misleading can hardly avoided. In the method and apparatus for determining an evaluation factor for a physiological condition provided in the present disclosure, risk factors based on knowledge and potential risk factors based on clinical data are comprehensively extracted, and both logistic regression model analysis and correlation analysis are used, which can effectively improve quality of the risk factors, decrease modeling dimension of a risk prediction model, reduce difficulty in establishing the risk prediction model and provide effective evaluation factors, thereby providing an effective basis for risk prediction of the physiological condition.

It should be understood that the above implementations are merely exemplary implementations adopted for explaining the principle of the present disclosure, but the present disclosure is not limited thereto. For those skilled in the art, various modifications and improvements may be made without departing from the spirit and essence of the present disclosure, and these modifications and improvements are also considered to be within the protection scope of the present disclosure.

What is claimed is:

1. A method for determining an evaluation factor for a physiological condition, comprising steps of:
obtaining a plurality of first risk factors based on knowledge for a physiological condition;
obtaining a plurality of potential second risk factors based on clinical data for the physiological condition;
performing logistic regression model analysis on the potential second risk factors to obtain second risk factors;
calculating, for each of the first risk factors, respective correlation coefficients between the first risk factor and the plurality of second risk factors to determine correlation between the first risk factors and the second risk factors; and
determining, based on the correlation between the first risk factors and the second risk factors, at least one first risk factor and at least one second risk factor that are valuable for the physiological condition to be evaluation factors for the physiological condition.

2. The method of claim 1, wherein a calculation formula for performing logistic regression model analysis on the potential second risk factors is:
$$F ( x ) = \frac{{e}^{t}}{( 1 + {e}^{t} )} = \frac{1}{( 1 + {e}^{- t} )} , \\ t = {β}_{0} + {β}_{1} {x}_{1} + {β}_{2} {x}_{2} + L + {β}_{n} {x}_{n} ,$$
where x₁, x₂, . . . xₙ are the potential second risk factors, n is the number of the potential second risk factors, and β₁, β₂, β₃, . . . , βₙ are regression coefficients corresponding to the potential second risk factors.

3. The method of claim 1, wherein the correlation coefficient r between the first risk factor and the second risk factors is calculated using a calculation formula:
$$r = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2}} \sqrt{{\sum }_{i = 1}^{n} {( {y}_{i} - \overline{y} )}^{2}}}$$
where X=(x₁, x₂, . . . , xₙ) and Y=(y₁, y₂, . . . , yₙ) are first risk factor data and second risk factor data, respectively, x and y are average values of X and Y, respectively, and n is the number of samples for the first risk factor and the number of samples for the second risk factor.

4. The method of claim 1, wherein the first risk factor and the second risk factor between which the correlation coefficient is smaller than 0.7 are determined to be the evaluation factors for the physiological condition.

5. The method of claim 1, wherein the plurality of first risk factors based on knowledge comprise evaluation factors extracted from medical journals or literature that have been used for evaluating the physiological condition; and
the plurality of second risk factors based on clinical data comprise at least one of personal general information, clinical diagnostic information, drug information, laboratory information and physiological index information.

6. The method of claim 2, wherein the plurality of first risk factors based on knowledge comprise evaluation factors extracted from medical journals or literature that have been used for evaluating the physiological condition; and
the plurality of second risk factors based on clinical data comprise at least one of personal general information, clinical diagnostic information, drug information, laboratory information and physiological index information.

7. The method of claim 3, wherein the plurality of first risk factors based on knowledge comprise evaluation factors extracted from medical journals or literature that have been used for evaluating the physiological condition; and
the plurality of second risk factors based on clinical data comprise at least one of personal general information, clinical diagnostic information, drug information, laboratory information and physiological index information.

8. The method of claim 4, wherein the plurality of first risk factors based on knowledge comprise evaluation factors extracted from medical journals or literature that have been used for evaluating the physiological condition; and
the plurality of second risk factors based on clinical data comprise at least one of personal general information, clinical diagnostic information, drug information, laboratory information and physiological index information.

9. An apparatus for determining an evaluation factor for a physiological condition, comprising:
a storage device; and
one or more processors coupled to the storage device,
wherein the storage device is configured to store computer-executable instructions for causing the one or more processor to:
obtain a plurality of first risk factors based on knowledge for a physiological condition;
obtain a plurality of potential second risk factors based on clinical data for the physiological condition;
perform logistic regression model analysis on the potential second risk factors to obtain second risk factors;
calculate, for each of the first risk factors, respective correlation coefficients between the first risk factor and the plurality of second risk factors to determine correlation between the first risk factors and the second risk factors; and
determine, based on the correlation between the first risk factors and the second risk factors, at least one first risk factor and at least one second risk factor that are valuable for the physiological condition to be the evaluation factors for the physiological condition.

10. The apparatus of claim 9, wherein a calculation formula for performing the logistic regression model analysis on the potential second risk factors is:
$$F ( x ) = \frac{{e}^{t}}{( 1 + {e}^{t} )} = \frac{1}{( 1 + {e}^{- t} )} , \\ t = {β}_{0} + {β}_{1} {x}_{1} + {β}_{2} {x}_{2} + L + {β}_{n} {x}_{n} ,$$
where x₁, x₂, . . . , xₙ are the potential second risk factors, n is the number of the potential second risk factors, and β₁, β₂, β₃, . . . , βₙ are regression coefficients corresponding to the potential second risk factors.

11. The apparatus of claim 9, wherein the correlation coefficient r between the first risk factor and the second risk factor is calculated using a calculation formula:
$$r = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2}} \sqrt{{\sum }_{i = 1}^{n} {( {y}_{i} - \overline{y} )}^{2}}}$$
where X=(x₁, x₂, . . . , xₙ) and Y=(y₁, y₂, . . . , yₙ) are first risk factor data and 15 second risk factor data, respectively, x and y are average values of X and Y, respectively, and n is the number of samples for the first risk factor and the number of samples for the second risk factor.

12. The apparatus of claim 9, wherein in the determination unit, the first risk factor and the second risk factor between which the correlation coefficient is smaller than 0.7 are determined to be the evaluation factors for the physiological condition.

13. The apparatus of claim 9, wherein
the plurality of first risk factors based on knowledge comprise evaluation factors extracted from medical journals or literature that have been used for evaluating the physiological condition; and
the plurality of second risk factors based on clinical data comprise at least one of personal general information, clinical diagnostic information, drug information, laboratory information and physiological index information.

14. The apparatus of claim 10, wherein
the plurality of first risk factors based on knowledge comprise evaluation factors extracted from medical journals or literature that have been used for evaluating the physiological condition; and
the plurality of second risk factors based on clinical data comprise at least one of personal general information, clinical diagnostic information, drug information, laboratory information and physiological index information.

15. The apparatus of claim 11, wherein
the plurality of first risk factors based on knowledge comprise evaluation factors extracted from medical journals or literature that have been used for evaluating the physiological condition; and
the plurality of second risk factors based on clinical data comprise at least one of personal general information, clinical diagnostic information, drug information, laboratory information and physiological index information.

16. The apparatus of claim 12, wherein
the plurality of first risk factors based on knowledge comprise evaluation factors extracted from medical journals or literature that have been used for evaluating the physiological condition; and
the plurality of second risk factors based on clinical data comprise at least one of personal general information, clinical diagnostic information, drug information, laboratory information and physiological index information.
